(19) United States
(12) Patent Application Publication
(10) Pub. No.: US 2003/0159283 A1
(43) Pub. Date: Aug. 28, 2003

(54) Optical fiber cable

(76) Inventor: Craig W. White, North Kingstown, RI (US)

Correspondence Address: DON E. ERICKSON, LAW OFFICE, PMB 182, 3830 VALLEY CENTER DRIVE #705, SAN DIEGO, CA, 92130-2331, US

(21) Appl. No.: 10/378,443

(22) Filed: Mar. 3, 2003

Related U.S. Application Data
(63) Continuation-in-part of application No. 09/557,580, filed on Apr. 22, 2000, now Pat. No. 6,557,249.

(51) Int. Cl. H01R 43/16; H01R 43/00

(52) U.S. Cl. 29/885; 29/874; 29/825

(57) ABSTRACT

The present invention is a strengthened fiber optic. The first embodiment of the invention consists of pre-coating a fiber optic waveguide with an ultra violet (UV)/visible light-curable resin such that the resin buffers the fiber waveguide. The pre-coated fiber optic waveguide is then cured in an UV/visible light oven at a temperature at ambient or above. An UV/visible light curable resin is pre-heated to a selected temperature and the buffered fiber optic waveguide and the at least one reinforcing fiber are transported through a binding resin bath, the fiber optic waveguide maintaining linear alignment throughout the bath as at least one reinforcing fiber is disposed about the fiber optic waveguide. The resin coated fiber optic waveguide and the at least one reinforcing fiber are then cured in an UV/visible light curing station so as to form a fiber optic cable. The second embodiment of the invention includes coating the fiber optic waveguide with a high temperature resin, such as a liquid crystalline polymer.

This application is a continuation-in-part of U.S. patent application Ser. No. 09/557,580 filed Apr. 22, 2000.

### BACKGROUND OF THE INVENTION

1. Field of the Invention

The present invention generally relates to the field of fiber optic communications and more particularly to fiber optic cables, and more particularly to a process and apparatus for installing and retrieving a fiber optic cable in difficult locations, such as oil, gas and geothermal well bores, buildings, vessels, such as aircraft and ships, conduits, or in other extreme or difficult environments. Specifically, the present invention provides a process for treating a fiber optic microcable to provide a strengthened member and means of inserting and retrieving the cable in such structures.

2. Background of the Art

Fiber optics are used to carry transmission signals for cable television applications, data transmissions, as well as for use as sensors in the measurement of temperatures and pressures under various conditions. More recently, due to their higher capacity for transferring data, inherent abilities to withstand temperature variances, ability to perform distributed temperature sensing, and their reduced size, optical fiber cable has started to replace conventional electronic cables and gauges. Frequently, when the purpose of deployment is for testing, an electrical conductor is also installed to operate a testing device or apparatus. In many instances, the optical fiber cable is deployed in a conduit that has already been installed in the structure. A fiber optic microcable is basically comprised of a glass or plastic fiber core, one or more buffer layers, and a protective sheath. If there are no means of pulling the cable into the conduit, then the optical fiber must be of a light weight, such as a single optical fiber strained, coated with a thin layer, 125 microns, of a protective material. Such an optical fiber strand is both fragile and flexible, however the light weight is necessary so that the optical fiber may be inserted over the full length of the conduit by means of pressurized fluid injection. The protective sheath is typically composed of a heat polymerized organic resin impregnated with reinforcing fibers. Depending on the optical fiber being used, the resin curing temperature and the method of cure can have an detrimental effect on the fiber. An unprotected fiber being ruggedized may be damaged during processing at temperatures of 200 C but after protection are able to withstand higher temperatures because of the support and protection offered by the cured composite reinforcements used. Alternatively the cable can be UV cured with resins that heretofore have limitation in both their processing and physical properties. In addition, the micro-cables frequently must be installed at lengths of up to 40,000 feet. State-of-the-art apparatus for installing such fiber optic microcable typically include means for pulling the cable from a cable reel, propelling the cable by means of tractor gears, or a capstan, and in some cases, impelling the cable through the duct by means of fluid drag. In some horizontal duct installations, a drogue is first fed through the duct, and the cable is then pulled through the duct by means of the drogue itself, or by a pulling line attached to the drogue at one end and the cable at the opposite end. All of the state-of-the-art methods for installing the cable place various stresses on the fiber optic core, causing degradation in the performance of the cable, and reducing the ability of the cable to resist conditions in which the cable may be installed.

U.S. Pat. No. 5,593,736 to Cowen discusses state-of-the-art processes for strengthening optical fiber cables, and details the reasons why the fiber optic properties are degraded by the strengthening processes. Cowen then describes and claims a process for fabricating a protective sheath about a fiber optic microcable, the process consisting of bathing the microcable in an ultraviolet light curable resin which may be impregnated with fibers to enhance the physical strength characteristics of the microcable. However, one of ordinary skill in the art would recognize that the cable of Cowen can not be installed in high-temperature environments due to the inherent properties of the resin. The resin of Cowen has a glass transition temperature range of 60-105° and a strain elongation at failure of 1½. Cowen teaches the use of a resin that has a low viscosity at ambient temperatures. Such a resin would break down at high temperatures. As such, the Cowen process does not produce a microcable sufficiently rugged to be used in well bores and other high temperature environs. In addition, the process of Cowen itself can cause degradation of the optical properties of the fiber optic cable. It has been discovered that passing the fiber optic cable through too many rollers aid/or tensioners, as with Cowen, can result in damage to the glass or plastic fiber core, cause micro-bends or broken fiber strands, and further degrade the cable. This is particularly true using standard telcom-grade multi-mode cable. Further, the process of Cowen cannot produce a cable that can be installed in high-temperature locations, the matrix coating of the cable of Cowen loses mechanical integrity and degrades rapidly at temperatures in excess of 150° C.

U.S. Pat. No. 4,479,984 to Levy et al. describes a process in which multi-filament bundles are impregnated with an ultraviolet curable resin to form a composite material suitable for use as a strength member in cables and other applications.

### SUMMARY OF THE INVENTION

The present invention provides a process and apparatus f-or installing a fiber optic microcable in structures, where integrity of the cable is critical, and where such strengthened cable may be deployed, which process and apparatus overcome problems inherent in the prior art of cable installation. The resin selected is not limited to low viscosities at ambient temperatures as needed by Cowen and such resins need not be applied at ambient temperatures. The result is a process which can use high performance resins, with higher viscosities than the Cowen process permits, that are applied at all elevated temperature, and when cured, allow the resultant microcable to withstand high temperature environments. The process permits the construction of a cable with a strain elongation at failure greater that 2%, and which can match the strain elongation at failure of the reinforcing members. The process provides for fabricating a protective sheath, comprised of an ultra violet (UV)/visible light curable resin, about a standard fiber optic cable. The resultant fiber optic cable is relatively semi-rigid, permitting the pushing of the fiber optic cable into the duct. The fiber optic cable is then led into a means for installation in said duct, and impelled in the duct to a selected location. For the purposes of this invention, a duct is defined to include any structure through which, or into which, it is desirable to insert fiber optic cable. The duct may be a channel, conduit, pipe, well bore, or tube, either in a closed or open system, all of which collectively will be referred to as a duct. The duct may be horizontal, vertical, slanted, or a combination of the foregoing, housed in aircraft, buildings, vessels, or in oil, gas or geothermal wells.

### OBJECTS OF THE INVENTION

One object of the invention is to produce a fiber optic cable that may be installed in a duct without degrading the optical properties of the fiber optic.

A second object of the invention is to produce a cable that is resistant to temperatures in excess of 260° C.

### BRIEF DESCRIPTION OF THE DRAWINGS

FIG. 1 is a schematic drawing of the process for installing a cable in a duct.

FIG. 2 is a pictorial drawing of one embodiment of the apparatus for strengthening the cable

FIG. 3 is a pictorial drawing of a second embodiment of the apparatus for strengthening the cable

FIG. 4 is a plane drawing of a guide plate of the apparatus.

FIG. 5 is a schematic drawing of the a third embodiment of the process having variable tensioning means.

### DESCRIPTION OF THE PREFERRED EMBODIMENT

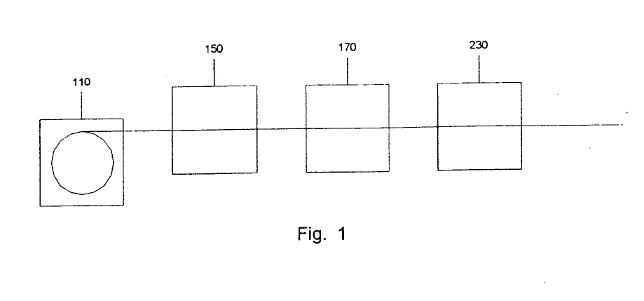

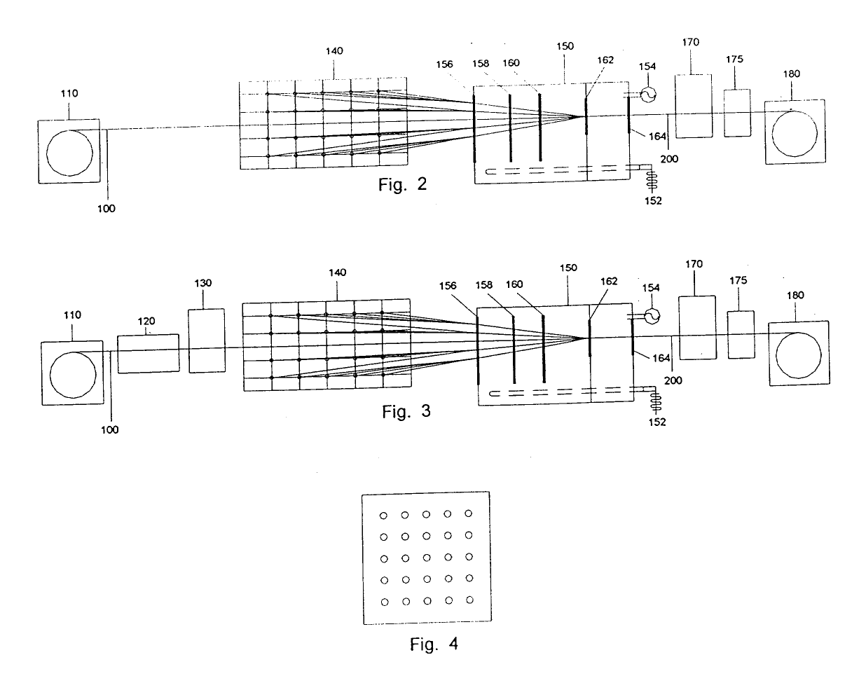

Referring to FIGS. 1 and 2, a fiber optic waveguide 100, as typically received from a manufacturer, includes a buffer and core, is shown on optic feed reel 110. Waveguide 100 is commercially available from various sources. Standard multimode fiber core is available from Corning. Alternatively, a hermetically sealed multimode fiber core, designed for high temperature, is available from Spectram. Reel system 140 contains a plurality of feed packages (not shown) containing reinforcing fibers 142. The number of reinforcing fibers 142 can be varied, dependent on the amount of tensile strength to be imparted to the cable. Such reinforcing fibers 142 may be glass, Aramid, carbon, Spectran, ultra high molecular weight polyolefin, or equivalent reinforcing material, and in some cases, an electrical conductor. The combined waveguide 100 and reinforcing fibers 142 are drawn from their respective reels and through resin bath 150 and UV/visible curing station 170 by pulling means 175. Pulling means 175 may be any conventional method for pulling cable, such as a capstan, winch, opposing tractors, or the like.

Waveguide 100 is fed directly to entry plate 151 of resin bath 150 without the need of being guided by feed rolls. Entry plate 151 (a plane view of which is depicted in FIG. 4) is adapted to sealingly receive both waveguide 100 and the plurality of reinforcing fibers 142 to allow fresh resins to continuously wet and lubricate the entrance opening of the waveguide 100 and the plurality of reinforcing fibers 142. The geometry of waveguide 100 in relation to reinforcing fibers 142 is determined when initially feeding waveguide 100 and reinforcing fibers 142 into resin bath 150 through entry plate 151, however, typically reinforcing fibers 142 are simultaneously pulled parallel to and radially about waveguide 100. In a preferred embodiment, resin bath 150 contains a UV/visible light curable resin, which is maintained at a constant temperature of between about 60° C. to about 100° C. by heating means 152, such as a re-circulating heat exchanger. The resin is re-circulated through resin bath 150 by pump 154 so as to create a resin flow in the direction opposite to the direction of pull of waveguide 100 and cable 200 through resin bath 150. The geometric relationship of waveguide 100 vis-á-vis reinforcing fibers 142 is maintained as they are drawn through resin bath 150 by cable guides 158 and 160, which have the same guide geometry as entry plate 156, but which provide a progressively convergent path in order to guide waveguide 100 and reinforcing fibers 142 to a convergent point at focal plate 162, which is sized to receive the resin coated waveguide 100 and reinforcing fibers 142 at a selected outside diameter. The resin of resin bath 150 is typically a formulation of high temperature heterocyclic methacrylate or heterocyclic acrylate, with heterocyclic acrylate being preferred, and with a cured glass transition of greater than 150° C. This formulation is optimal for reinforcing a cable that may encounter temperatures in excess of 200° C. In those situations where a maximum temperature of 200° C. may be encountered, a formulation using less or no heterocyclic (meth)acrylate may be used. In such case, a high performance vinyl ester or a high temperature epoxy may be used, as would be known by one of ordinary skill in the art.

In the preferred embodiment, a non-robust soft coating is placed on the optical fiber prior to the reinforcing the fiber optic. However, it should be noted that the use of silicone; a soft acrylate, urethane or similar resin could also be employed.

If a high temperature resin is used with a high temperature optical fiber, some of the constraints on processing temperatures are not as important. It is therefore possible to use a reactive system. The reactive system can be either a one-part heat activated system or a multi-part cure upon mixing system, i.e., like a typical two-part epoxy system. It should be noted that the resin could be a formulation comprising a resin, such as oligomer; modifiers such as monomers, that may include acrylic resins; and/or a curing agent, photo-initiators or heat activated free radicals, an example of which is benzoyl peroxide. Note that while it is possible to use these systems, they would have to be especially formulated to handle the high end use temperatures. Also note that, while possible, all these systems have some disadvantages in processing compared to the UV system.

Alternatively, if a high temperature optical fiber is used, it may be possible to use a type of polymer known as a Liquid Crystalline Polymer as the resin. The LCP is a thermoplastic resin and as such does not need to be cured. Because the thermoplastic resin is in a fluid state during the coating, or extrusion, of the fiber optic, it is difficult control specific tension imparted on the resultant cable. In addition because the LCP is such a high temperature resin, the application temperature is also very high, in the range of 700° F. This high temperature could adversely affect the optical properties of the waveguide. This polymer may not be cost competitive, but it potentially could produce a self-reinforcing, resin. Another possibility would be to use a combination of the above resin systems or a variation thereof, but using short fiber reinforcements. This would be practical with some of the new nano-carbon fibers currently being made. At this time such nano-carbon fibers are only available is small quantities and are very expensive. In this application, reinforcing fibers would not be required. However, in this embodiment, resin bath 150 would be an extruder 150 wherein all of the fibers of the liquid crystalline polymers would be aligned during the extrusion process.

It is understood that the number of holes in entry plate 156 and cable guides 158 and 160 can be of any selected number, and that typically waveguide 100 will be fed through a center hole with strength members radially and uniformly disposed about waveguide 100.

Upon exit from focal plate 162 the combined waveguide 100 and reinforcing fibers 142 now form a cable 200 which is pulled through the remaining portion of resin bath 150 and through exit plate 164, which is also sized to a selected diameter to remove undesired amounts of resin. Resin coated cable 200 is then drawn through an ultra-violet/visible light curing station 170 at a constant speed of 20 feet per minute, curing station 170 having a power rating of 300 watts per inch, and having a curling zone of 10 inches in length. Such UV/visible light ovens are commercially available from Fusion and are well known in the art. The above rate, power rating length, and number of curing units are not limitations of the invention. The speed through curing station 170 is only dependent on the power of the curing station and the formulation of the UV/visible light curable resin. Curing stations may have a rating greater than 300 watts. The length of the curing zone is either increased or decreased dependent upon the power of the curing station and the curing characteristics of the resin, varying from about 1 inch to about 96 inches, as would be understood by one of ordinary skill in the art. While the UV process is the most practical means of curing high temperature resin, it is possible to cure using other radiation sources. One such type would be an electron beam, which functions well, but at a high cost. Another curing means would be to use an initiator system sensitive to the visible light spectrum, possible but not desirable. In the embodiment where a liquid crystalline polymer is extruded about to waveguide 100, to produce fiber optic cable 200, curing station 170 would then be adapted to be a heating or cooling station, based on the formulation of the resin.

In most cases it is desirable to have zero residual strain on the optical fiber and therefore match specific tensions of the reinforcements and the optical fibers such the resultant cable 200 has zero residual stress on the optical fiber. However, in some instances, independent, accurate and electronic tension control of both reinforcements and optical fiber combined with mini mum contact points provide some advantages. For example where cable 200 is to be used under tension, having cable 200 made with waveguide 100 under residual compression allows higher working strains for a given construction. This can be accomplished by having the specific tension of reinforcing fibers higher than the specific tensions of the cable 200 and reinforcing fibers 142.

It is also possible to construct cable 200 where there is residual tensile stress put on the cable 200. This can be accomplished by having the specific tension of reinforcing fibers 142 lower than the specific tensions of waveguide 100. This can be useful cable 200 is used under compression, such as when the fiber is pushed into a tube i.e. in oil well capillary tubing. Another potential use is where having an optical fiber under tension enhances other properties of interest such as sensitivity to temperature variations.

Another option is to be able to construct cable 200 with residual stress on waveguide 100 varying throughout the rod in any preferred profile. One example would where the waveguide 100 varies from stress to selectively being under compression. This would allow a long length of cable 200 to be extended in a vertical mode in either air or water yet having waveguide 100 be under zero resultant strain in use. Another application would be constructing cable 200 where a specific section is under either tension or compression allowing for the section of increased sensitivity of cable 200 to be placed where most needed without affecting other sections of cable 200.

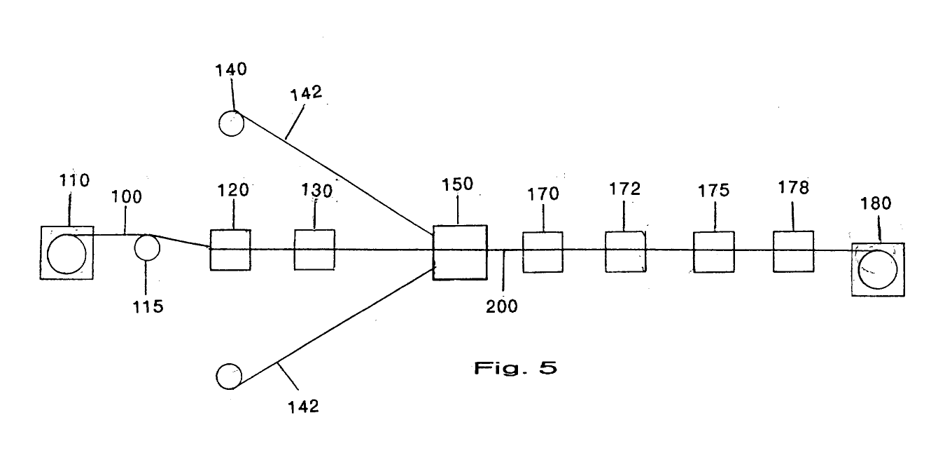

FIG. 5 depicts tensioning reinforcement let-off control 115 and tensioner control 178 which maintains a selected tension on waveguide 100 and reinforcing fibers 142 through curing station 170. The tension for both the optical fiber and the tension on the reinforcements are independently controllable. The relative tensions are “locked” into place during the curing station and are tensioned from reinforcement let-off 115 to the pulling means 175, consisting of a drive, or puller wheels. The tension on the cable before the puller wheels is the process tension. The tension on the cable, after the puller or drive wheel, is the winding tension and each is independent and controllable. Tension control on optical fiber 100 is maintained from tensioner 115 through pulling means 175, whereas tension on reinforcing cable is controlled from 140 through pulling means 175. Tensioner 178 may be comprised of any typical cable pulling apparatus, such as a capstan drive, or tractor wheels.

Upon curing, cable 200 is disposed on take-up reel 180, or alternatively, fed directly into the means for inserting cable 200 in the duct, as described below. The silicone-sheathed cable and strength members are then collected on a storage means, such as a cable reel. Alternatively, the strengthened cable may be fed directly into the means for inserting the cable into a duct as described below.

FIG. 3 depicts a second embodiment of the invention wherein the waveguide 100 is additionally pre-treated with an UV/visible light curable soft cushioning buffer layer prior to being fed into the resin bath of FIG. 2. Tile buffer layer provides an additional sheath about the periphery of the fiber of approximate thickness of 50 microns. This additional buffer layer can be a low modulus/soft silicone buffering resin, or some equivalent non-silicone soft resin. As in the first embodiment, waveguide 100 is drawn from reel 110, and is then fed through a pretreatment resin bath 120 containing an UV/visible light curable silicone resin, which resin is maintained at ambient temperature. Thus, the optical waveguide is pre-coated with a silicone or like low modulus resin, the combined optical fiber and reinforcements are then coated and combined in a bath containing the high temperature resin typically the heterocyclic acrylate. The fully formed microcable is then cured in the UV station.

If it is desired to increase the linear speed of the line, the temperature may be raised from ambient to about 60° C. The parameters of treating waveguide 100 at ambient temperature are taught in Cowen. Waveguide 100 coated with the UV/visible light silicone resin is then fed into UV/visible light curing station 130, wherein the resin cures to provide a buffered fiber, which is then fed in to resin bath 150 in the same manner as in the first embodiment. While it is possible to use an inline buffer coating as in the above paragraph, it should also be noted that a pre-buffered fiber, i.e. a tight buffer optical fiber, could be used in the construction, such as a 700 micron tight buffered optical fiber.

As in the first embodiment, the optic strand is drawn from feed reel 10 into pre-treat resin bath 120, through UV/visible light curing station 130, into resin bath 150, through UV/visible light curing station 170 and to take-up reel 180, or directly to the injection means process described below, in a substantially linear path, and without being guided around any feed rolls in a manner that would tend to cause degradation of the optical properties of the fiber optic cable. Although the above embodiments have been discussed in terms of resin coating only one waveguide 100, it is contemplated that a plurality of waveguides and a plurality of reinforcing fibers could be combined in one cable.

Subsequent to curing cable 200, it may be desirous to topcoat cable 200 with a material that would ease the insertion of cable 200 into various environments. For example the topcoat may consist of silicone modified heterocyclical acrylate which reduces surface coefficient of friction, and which would be applied to cable 200 in topcoat station 172. Other topcoats for various conditions may be applied as would be known by one of ordinary skill in the art.

Since cable 200 is of semi-rigid construction, it may be deployed and used in a manner hereto not possible. It is well known that the protective surfaces of cables for instruments, including fiber optic cable, deteriorate sufficiently over time in oil, gas, and geothermal well bores, and other corrosive or remote locations, due the high temperature and corrosive natures of the fluids in such well bores or locations, to become unstable and unusable. Yet it may be desirable to be able to periodically monitor parameters in the well bore without having to run a new fiber optic installation each time. It would be advantageous to install the instruments in the well bore and attached to the standard tubing permanently installed in the well bore. With the cable of the invention, such instruments may be adapted with a sealed optical coupler to receive the semi-rigid cable 200, then when it is desirable to monitor the well bore conditions, cable 200 is inserted in the well to the location of the selected instrument, into the optical coupler, permitting monitoring of the well bore.

Concomitantly, reinforcing fibers 142 could include an electrical conductor which could then be used to power the remote instrument, or a conductor could be attached to cable 200 upon insertion of cable 200 in the duct, permitting installation of the electrical cable with cable 200.

While the present description contains much specificity, this should not be construed as limitations on the scope of the invention, but rather as exemplifications of one/some preferred embodiment/s thereof. The fall scope of the invention is further illustrated by the claims appended hereto.

I claim:

1. A process for making a strengthened cable, the process comprising the steps of:
(a) receiving a fiber optic waveguide from a source;
(b) disposing at least one reinforcing fiber about the fiber optic waveguide;
(c) simultaneously coating the fiber optic waveguide and the at least one reinforcing fiber with a resin, the resin for binding the fiber optic waveguide and the at least one reinforcing fiber, the resin consisting of a high temperature resin;
(d) curing the binding resin coated fiber optic waveguide and the at least one reinforcing fiber so as to form a semi-flexible cable; and
(e) collecting the fiber optic cable.

2. The process of claim 1 wherein the step for receiving the fiber optic waveguide includes:
(a) linearly aligning the fiber optic waveguide with a means for imparting the resin; and
(b) transporting the fiber optic waveguide to the means for imparting the resin.

3. The process of claim 1 wherein the high temperature resin is UV/visible light curable.

4. The process of claim 3 wherein the UV/visible light curable resin is selected from heterocyclic acrylates and heterocyclic methacrylates.

5. The process of claim 3 wherein the step of curing the resin is with UV/visible light.

6. The process of claim 1 wherein the high temperature resin is selected from the group of high performance vinyl esters, polymers, high heterocylical resins, and high temperature epoxies.

7. The process of claim 6 wherein the step of curing the resin is reactive.

8. The process of claim 2 wherein the step for transporting the fiber optic includes transporting the fiber optic waveguide by means of feed rolls and bobbins in a substantially linear alignment to the means for imparting the resin to the fiber optic waveguide and the at least one reinforcing fiber.

9. The process of claim 1 wherein the resin is a formulation of resin, modifiers and Curing agent.

10. The process of claim 1 wherein the step of simultaneously coating the fiber optic waveguide and the at least one reinforcing fiber with a resin includes transporting the fiber optic waveguide and the at least one reinforcing fiber through a resin bath.

11. The process of claim 10 wherein the step of transporting the fiber optic waveguide and the at least one reinforcing fiber through the resin bath includes transporting the fiber optic waveguide and the at least one reinforcing fiber through a plurality of plates defining orifices for receiving the fiber optic waveguide and the at least one reinforcing fiber, the plurality of plates providing a guide path through the resin bath for the fiber optic waveguide and the at least one reinforcing fiber.

12. The process of claim 10 wherein the step of simultaneously coating the fiber optic waveguide and the at least one reinforcing fiber with a binding resin includes heating the resin to a selected temperature prior to transporting tile fiber optic waveguide and the at least one reinforcing fiber through the resin bath.

13. The process of claim 12 wherein the step of heating the resin to a selected temperature includes maintaining the temperature of the resin in a selected range.

14. The process of claim 10 wherein the step of simultaneously coating the fiber optic waveguide and the at least one reinforcing fiber with a binding resin includes re-circulating the resin through the resin bath.

15. The process of claim 14 wherein the step of re-circulating the resin includes re-circulating the resin in a direction opposite the direction of transportation of the fiber optic waveguide and the at least one reinforcing fiber.

16. The process of claim 1 wherein the step of curing the binding resin-coated fiber optic waveguide and the at least one reinforcing fiber includes the step of transporting the binding resin-coated fiber optic waveguide and the at least one reinforcing fiber through a curing station at a constant speed of about 5 up to about 300 feet per minute, the curing station having a power rating of greater than 200 watts per inch, and having a length of about 1 inch to about 96 inches.

17. The process of claim 1 wherein the binding resin is selected such that it has a strain elongation at failure greater that 2%.

18. The process of claim 1 wherein the at least one reinforcing fiber is selected for the group of Aramid, carbon, glass, and ultra-high molecular weight polyolefin.

19. The process of claim 1 wherein at least one of the reinforcing fiber is an electrical conductor.

20. Tile process of claim 1 wherein the steps of coating and curing the resin coated fiber optic waveguide and the at least one reinforcing fiber includes the step of selectively tensioning the resin coated fiber optic waveguide and the at least one reinforcing fiber at selected locations of the fiber optic waveguide.

21. The process of claim 1 wherein the step of receiving a fiber optic waveguide includes the step of pre-coating the fiber optic waveguide with a low modulus buffering resin, the resin selected to buffer the fiber optic waveguide at a temperature of about ambient or above, the step of pre-coating the fiber optic waveguide occurring before the step of disposing at least one reinforcing fiber about the fiber optic waveguide.

22. The process of claim 21 wherein the step of pre-coating the fiber optic waveguide includes the step of curing the pre-coated fiber optic waveguide.

23. The process of claim 21 wherein the low modulus buffering resin is an UV/visible light curable silicone.

24. The process of claim 21 wherein the low modulus buffering resin is selected from urethane, acrylate, silicone and equivalent soft resins.

25. The process of claim 1 wherein the step of collecting the fiber optic cable includes the step of top-coating the fiber optic waveguide.

26. The process of claim 25 wherein the topcoat consists of silicone modified heterocyclical acrylate

27. A process for making a strengthened cable, the process comprising the steps of:
(a) receiving a fiber optic waveguide from a source;
(b) coating the fiber optic waveguide within a resin, the resin comprising a high temperature polymer, the resin for reinforcing the fiber optic waveguide so as to form a semi-flexible cable; and;
(c) collecting the fiber optic cable.

28. The process of claim 27 wherein the step for receiving the fiber optic waveguide includes:
(a) linearly aligning the fiber optic waveguide with a means for imparting the resin; and
(b) transporting the fiber optic waveguide to the means for imparting the resin.

29. The process of claim 27 wherein the step for transporting the fiber optic includes transporting the fiber optic waveguide by means of feed rolls and bobbins in a substantially linear alignment to the means for imparting the resin to the fiber optic waveguide and the at least one reinforcing fiber.

30. The process of claim 25 wherein the reinforcing resin is a liquid crystalline polymer.

31. The process of claim 27 wherein the reinforcing resin is formulated to include nano-carbon fibers.

32. The process of claim 27 wherein the step of coating the fiber optic waveguide with a reinforcing resin includes transporting the fiber optic waveguide through a bath of reinforcing resin.

33. The process of claim 32 wherein the step of transporting the fiber optic waveguide through the resin bath includes transporting the fiber optic waveguide through a plurality of plates defining orifices for receiving the fiber optic waveguide, the plurality of plates providing a guide path through the resin bath for the fiber optic waveguide.

34. The process of claim 32 wherein the step of coating the fiber optic waveguide with a reinforcing resin includes heating the resin to a selected temperature prior to transporting, the fiber optic waveguide through the resin bath.

35. The process of claim 34 wherein the step of heating the resin to a selected temperature includes maintaining the temperature of the resin in a selected range.

36. The process of claim 32 wherein the step coating the fiber optic waveguide with a reinforcing resin includes re-circulating the resin through the resin bath.

37. The process of claim 36 wherein the step of re-circulating the resin includes re-circulating the resin in a direction opposite the direction of transportation of the fiber optic waveguide.

38. The process of claim 27 wherein the binding resin is selected such that it imparts a strain elongation at failure greater that 2% to the fiber optic cable.

39. Tile process of claim 27 wherein the step of receiving a fiber optic waveguide from a source additionally includes the steps of,
(f) disposing at least one reinforcing fiber about the fiber optic waveguide;
(g) simultaneously coating the fiber optic waveguide and the at least one reinforcing fiber with the reinforcing resin.

40. The process of claim 39 wherein the at least one reinforcing fiber is selected from the group of Aramid, carbon, glass, and ultra-high molecular weight polyolefin.

41. The process of claim 39 wherein at least one of the reinforcing fiber is an electrical conductor.

42. The process of claim 27 wherein the steps of coating the reinforcing resin coated fiber optic waveguide includes the step of selectively tensioning the resin coated fiber optic waveguide at selected locations of the fiber optic waveguide.

43. The process of claim 27 wherein the step of receiving a fiber optic waveguide includes the step of pre-coating the fiber optic waveguide with a low modulus buffering resin, the resin selected to buffer the fiber optic waveguide at a temperature of about ambient or above, the step of pre-coating the fiber optic waveguide occurring before the step of coating the fiber optic waveguide with a resin.

44. The process of claim 43 wherein the step of pre-coating the fiber optic waveguide includes the step of curing the pre-coated fiber optic waveguide.

45. The process of claim 43 wherein the low modulus buffering resin is an UV/visible light curable silicone.

46. The process of claim 43 wherein the low modulus buffering resin is selected from the group of silicone and equivalent soft resins.

47. The process of claim 27 wherein the step of collecting the fiber optic cable includes the step of top-coating the fiber optic waveguide.

48. The process of claim 47 wherein the topcoat consists of silicone modified heterocyclical acrylate
